(19) United States
(12) Patent Application Publication
(10) Pub. No.: US 2025/0111970 A1
(43) Pub. Date: Apr. 3, 2025

(54) Inductive Component and Preparation Method Therefor

(71) Applicants: HUIZHOU POCO NEW INDUCTOR TECHNOLOGY CO., LTD., Huizhou (CN); HEYUAN POCO NEW MATERIAL CO., LTD., Heyuan (CN)

(72) Inventors: Yunfan Zhang, Shenzhen (CN); Xiongzhi Guo, Shenzhen (CN); Tao Luo, ShenZhen (CN); Yaqing Li, ShenZhen (CN); Zhida Liu, ShenZhen (CN)

(73) Assignees: HUIZHOU POCO NEW INDUCTOR TECHNOLOGY CO., LTD., Huizhou (CN); HEYUAN POCO NEW MATERIAL CO., LTD., Heyuan (CN)

(21) Appl. No.: 18/898,803

(22) Filed: Sep. 27, 2024

(30) Foreign Application Priority Data
Sep. 28, 2023 (CN) 202311275730.8

(51) Int. Cl. H01F 5/04; H01F 5/06; H01F 37/00; H01F 41/02; H01F 41/10; H01F 41/12

(52) U.S. Cl. CPC H01F 5/04; H01F 5/06; H01F 37/00; H01F 41/0246; H01F 41/10; H01F 41/12

(57) ABSTRACT

Provided are an inductive component and a preparation method therefor. The inductive component includes: a magnetic core; wherein the magnetic core is externally covered with an insulating material; the insulating material is internally arranged with a through hole; the through hole is internally arranged with a first metal conductor; wherein the first metal conductor includes any one or a combination of at least two of a winding, a power path, or a signal path. The inductive component has a simple structure, high integration level, high planeness, and high reliability, which can effectively reduce the process difficulty of the subsequent soldering process, reduce the footprint, and improve the power density of the power supply module.

### CROSS-REFERENCE TO RELATED APPLICATIONS

This application claims priority to Chinese Patent Application No. 202311275730.8 filed Sep. 28, 2023, the disclosure of which is incorporated herein by reference in its entirety.

### TECHNICAL FIELD

The present application belongs to the technical field of inductors, relates to an inductive component and a preparation method therefor, and in particular to an inductive component for vertical power delivery and a preparation method therefor.

### BACKGROUND

In recent years, with the development of data centers, artificial intelligence and other technologies, the central processing unit (CPU), graphics processing unit (GPU) and various types of integrated chip (IC) have an increasingly fast working speed, an increasingly high integration level, and an increasingly large working current. When the current increases, the system circuit board is affected by the size and process due to the thickness of laid copper, the resistance is large, and the power consumption is too high; the power supply current levels of various processing units continue to increase, and its peripheral power supply inductive components have problems such as large size and large footprint to be solved.

For existing power modules (such as CN116471807A), metal connectors are usually spliced outside the inductor body to improve module integration (as shown in FIG. 1), wherein the external-pasted metal parts with a large cross-sectional area are used to pass the circuit current, the metal connectors with a relatively small cross-sectional area form a signal path of the upper circuit and lower circuit, and there is also a way to realize the circuit signal path by using a PCB. The metal parts or PCB are bonded to the inductor body by glue, and there will be some gap between them, resulting in low space utilization and large footprint. In addition, the mechanical bonding of multiple parts may result in an uneven surface, which can affect the yield of subsequent power modules and have a reliability risk.

### SUMMARY

The present application provides an inductive component and a preparation method therefor. The inductive component has a simple structure, high integration level, high planeness, and high reliability, which can effectively reduce the process difficulty of the subsequent soldering process, reduce the footprint, and improve the power density of the power supply module.

In a first aspect, the present application provides an inductive component, and the inductive component includes: a magnetic core; wherein the magnetic core is externally covered with an insulating material; the insulating material is internally arranged with a through hole; the through hole is internally arranged with a first metal conductor; wherein the first metal conductor includes any one or a combination of at least two of a winding, a power path, or a signal path.

As a preferred technical solution of the present application, the through hole is a vertical through hole.

As a preferred technical solution of the present application, a method of arranging the first metal conductor inside the through hole is metallization or casting.

As a preferred technical solution of the present application, the inductive component further includes a second metal conductor, and the second metal conductor is arranged in contact with the magnetic core.

Preferably, the second metal conductor includes a winding and/or a power path.

As a preferred technical solution of the present application, the surface of the magnetic core is arranged with a vertical through groove structure, and the through hole is arranged in the insulating material inside the groove structure.

As a preferred technical solution of the present application, the surface of the inductive component is arranged with a pad, and the pad is connected to the first metal conductor.

As a preferred technical solution of the present application, the pad is independently connected to the first metal conductor and the second metal conductor, respectively.

In a second aspect, the present application provides a preparation method for the inductive component described in the first aspect, and the preparation method includes: performing a first press-fitting to prepare a magnetic core; performing a second press-fitting to coat the insulating material on the magnetic core; drilling on the insulating material to obtain a through hole; and preparing a first metal conductor inside the through hole.

As a preferred technical solution of the present application, the preparation method includes performing a first press-fitting to prepare a magnetic core and a second metal conductor.

As a preferred technical solution of the present application, the preparation method includes performing a first press-fitting to prepare a magnetic core having a vertical through groove structure.

As a preferred technical solution of the present application, the preparation method further includes soldering the pad to the first metal conductor.

Preferably, the pad is arranged on one side of the inductive component, and soldered with the first metal conductor to form a T-shape.

Preferably, the pad is arranged on both sides of the inductive component, and soldered with the first metal conductor to form an I-shape.

Compared with the prior art, the present application has at least the following beneficial effects:
(1) the present application provides an inductive component, the inductive component has a simple structure, high integration level, high planeness, and high reliability, which can effectively reduce the process difficulty of the subsequent soldering process, reduce the footprint, and improve the power density of the power supply module; and
(2) the present application provides a preparation method for an inductive component, the preparation method has a simple process and high controllability, which is suitable for large-scale industrialized production.

### BRIEF DESCRIPTION OF THE DRAWINGS

FIG. 1 is a structural schematic diagram of an inductive component in the prior power supply module.

FIG. 2 is a structural schematic diagram of the inductive component provided in Example 1 of the present application.

FIG. 3 is a perspective structural schematic diagram of the inductive component provided in Example 1 of the present application.

FIG. 4 is a structural schematic diagram of the inductive component provided in Example 2 of the present application.

FIG. 5 is a structural schematic diagram of the inductive component provided in Example 3 of the present application.

FIG. 6 shows a comparative structural diagram of an inductive component with a groove in the magnetic core and an inductive component without a groove in the magnetic core provided by specific embodiments of the present application.

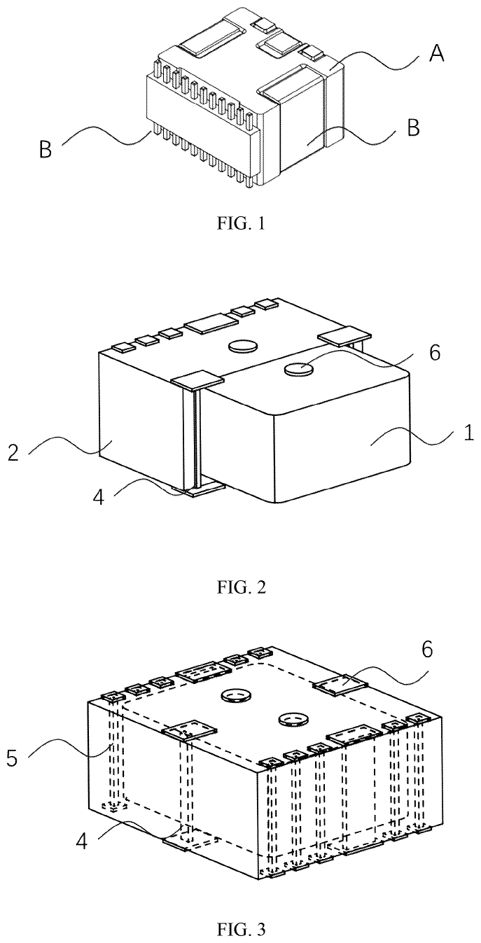

Reference list: 1— magnetic core, 2— insulating material, 3— winding, 4— power path, 5—signal path, 6— pad, A— inductor body, and B— metal connector.

### DETAILED DESCRIPTION

The present application is described in further detail below. However, the following examples are only simple examples of the present application, and do not represent or limit the protection scope of the claims of the present application. The protection scope of the present application is subject to the claims.

The technical solution of the present application is further described below by specific embodiments.

The specific embodiments of the present application provide an inductive component, and the inductive component includes: a magnetic core; wherein the magnetic core is externally covered with an insulating material; the insulating material is internally arranged with a through hole; the through hole is internally arranged with a first metal conductor; wherein the first metal conductor includes any one or a combination of at least two of a winding, a power path, or a signal path.

In addition to playing the role of energy storage and voltage regulation, the inductor component provided in the present application also integrate multiple functions as a whole, including receiving power supply current, input voltage and ground voltage, and transmission signals, which is very conducive to reducing the footprint to achieve the miniaturization of power supply modules; the inductor is an integrated molding structure rather than a mechanical assembly of multiple parts, which has the characteristics of good planeness, and can reduce the usage amount of solder paste in the soldering process, reduce the contact resistance, and at the same time, reduce the risk of pseudo soldering and improve the process yields. The metal paths are located inside the inductor, which can avoid friction, board cutting and other actions that may cause path breakage or defects, thus improving the working reliability of the inductor components.

In the present application, the current flowing in the winding can generate a magnetic field, which has the effect of energy storage; the power supply path can receive the input voltage and reference ground voltage in the power module; and the signal path can be connected to the chip of the power module for transmitting signals such as current and temperature.

In one specific embodiment of the present application, the first metal conductor is arranged inside the through hole by metallization or casting.

In one specific embodiment of the present application, the magnetic core includes soft magnetic powder particles, and the specific material of the soft magnetic powder may be specifically selected according to the performance requirements of the inductive component, which is not specifically limited herein. For example, the material of the soft magnetic powder may be Fe, Fe—Si, Fe—Si—Al, Fe—Ni, Fe—Si—B—Nb—Cu, Fe—Si—B, or Fe—B.

In one specific embodiment of the present application, the insulating material is a non-magnetic and non-conductive resin material resistant to a temperature of about 300° C. and a thermal conductivity within 0.6-2 W/(m-K).

In one specific embodiment of the present application, the insulating material has a thickness of 50 m to 0.5 mm. If the thickness is less than 50 m, there is a risk of breakage, which will lead to the inductor body being exposed to the external environment, thereby absorbing water vapor, chemical solutions and other substances to result in rust, cracking and other problems; if the thickness is more than 0.5 mm, which will affect the heat dissipation of inductors, resulting in a high loss of inductors.

In one specific embodiment of the present application, the through hole is a vertical through hole, i.e., through the upper surface and lower surface of the magnetic core, so that the first metal conductor arranged in the vertical through hole runs through the magnetic core from top to bottom to achieve a vertical power supply. The through hole refers to a hole inside the insulating material to accommodate the first metal conductor, which may be formed by drilling a hole in the insulating material or formed by other processes, for example, first forming an insulating material on the surface of the magnetic core, then using metallization to form the first metal conductor, and finally coating with the insulating material. It can be understood that the insulating material may be epoxy resin, phenolic resin, etc., which can be selected according to the actual process, and will not be specifically limited herein.

In one specific embodiment of the present application, in a case where the first metal conductor includes only a power path and/or a signal path, the vertical through holes are arranged only inside the insulating material which is coated on the magnetic core, i.e., the maximum parallel size of the vertical through hole is smaller than the thickness of the insulating material. In a case where the first metal conductor includes a winding, the vertical through hole is also arranged inside the insulating material which fills the through hole inside the magnetic core.

In one specific embodiment of the present application, the number of vertical through holes and the shape of the cross-section are provided according to the requirements of the first metal conductor, which are not specifically limited herein. For example, the number of the vertical through holes may be from 1 to 50, such as 1, 2, 5, 8, 10, 15, 20, 25, 30, 35, 40, 45, or 50, but the number is not limited to the listed values, and other unlisted values within the range of the numerical values are also applicable; a shape of the cross-section of the vertical through hole may be a triangle, a rectangle, a semicircle, a circle, an ellipse, etc.

In one specific embodiment of the present application, the material of the first metal conductor is a metal which is commonly used for windings, power paths, and signal paths in the field of inductors. The metal may be a metallic element or an alloy, which may be selected according to the performance, processing difficulty, and cost of the inductive components, and is not specifically limited herein. For example, the material of the first metal conductor may be copper or silver.

In one specific embodiment of the present application, the material of the second metal conductor is a metal commonly used for windings and power paths in the field of inductors, and the metal may be a metallic element or an alloy, which may be selected according to the performance, processing difficulty, and cost of the inductive components, and is not specifically limited herein. For example, the material of the second metal conductor may be copper or silver.

In one specific embodiment of the present application, a vertical through groove structure is arranged on the surface of the magnetic core, the insulating material is arranged inside the groove structure, and the “vertical through” is arranged wholly or partially in the insulating material inside the groove structure. A cross-sectional shape of the groove structure may be set according to the cross-sectional shape of the first metal conductor.

In the present application, the arrangement of the groove structure on the surface of the magnetic core can further reduce the volume of the inductor or increase the proportion of magnetic material under the same volume, so as to increase the effective magnetic volume of the inductor and increase the inductance, as shown in FIG. 6.

In one specific embodiment of the present application, the pads are located on the top surface and bottom surface of the inductor, and chemically bonded to the metal conductor, and the surface of the pads is not lower than the surface of the insulating material.

In one specific embodiment of the present application, the pad is larger than the cross-sectional area of the metal conductor, and forms an I-shape from top to bottom. In order to save inductor volume and increase the proportion of the soft magnetic material, the cross-section of the metal conductor is usually set to the smallest cross-section that is acceptable for inductive performance; in order to increase the soldering strength, the C-shape, which coats on the side of the inductor and extends over the top surface and bottom surface, is now commonly used to increase the soldering area. The I-shape further reduces the risk of breakage between the pad and conductor, improves soldering reliability, and is useful for the stable transmission of signals.

In one specific embodiment of the present application, the pad is made from a material including copper, nickel, tin, or gold.

In one specific embodiment of the present application, a metal layer, such as a copper foil, may be arranged between the insulating material and the magnetic core to avoid signal interference to the signal path by other paths.

A specific embodiment of the present application provides a preparation method for an inductive component, and the preparation method includes: performing a first press-fitting to prepare a magnetic core; performing a second press-fitting to coat the insulating material on the magnetic core; drilling on the insulating material to obtain a through hole; and preparing a first metal conductor inside the through hole.

In the present application, the magnetic powder particles are subjected to a first press-fitting to form a magnetic core; the insulating material is coated on the surface of the magnetic core, and subjected to a second press-fitting to form an integrated structure with a specific regular shape; the first metal conductor directly contacts the insulating material, a through hole is formed in the insulating material, and then forms the first metal conductor in the through hole. The insulating material and the first metal conductor have a high bonding strength, and the size accuracy can be controlled to the micro-meter level; the combination of the above processes can effectively reduce the volume of the product.

In one specific embodiment of the present application, the insulating material is drilled and the obtained through hole may be a vertical through hole.

In one specific embodiment of the present application, in a case where the metal conductor has a large cross-section, it can be prepared by the first press-fitting together with the magnetic core; in a case where the metal conductor has a small cross-section, it is more suitable for preparing inside the vertical through hole. Because different metal conductors play different roles in the circuit, the requirements for their cross-sectional area and conductivity are also different. The winding and power path generally pass a large current (more than or equal to 10 A), while the signal path current is less than or equal to mA, so the cross-sections of the winding and power path are larger than that of the signal path. Therefore, the winding and the power supply path can be realized by press-fitting, or preparing inside the vertical through hole, and preparing inside the vertical through hole can better achieve the object of reducing the occupied volume of the signal path.

In one specific embodiment of the present application, the first press-fitting and the second press-fitting are the commonly used press-fitting processes in the field of electronic parts, and the specific conditions are not specifically limited herein. For example, the condition of the first press-fitting and the condition of the second press-fitting are independent, the first press-fitting can be compression molding, wherein cold pressing or hot pressing is optional; the second press-fitting can be injection molding or hot-press molding, and if the insulating material has a certain fluidity, injection molding will be used, and on the contrary, hot-press molding will be used.

In one specific embodiment of the present application, a method of drilling the insulating material to prepare the through hole can be mechanical drilling or laser drilling.

In one specific embodiment of the present application, in a case where the first metal conductor includes a winding, and the preparation method for the winding includes arranging a through hole inside the magnetic core (the arranging method may be drilling, or integrated molding by a mold in the first press-fitting), filling the insulating material inside the through hole during the second press-fitting, drilling the insulating material inside the through hole to obtain a vertical through hole, and performing metallization to prepare the winding.

In one specific embodiment of the present application, the preparation of the first metal conductor inside the vertical through hole may be metallization.

In one specific embodiment of the present application, the first metal conductor is prepared inside the vertical through hole by melting the material of the first metal conductor to a liquid state, and injecting the melted metal into the inside of the vertical through hole, and performing a certain cooling process to obtain the first metal conductor. It should be noted that in a case where the first metal conductor is formed inside the vertical through hole in this way, the melting temperature of the first metal conductor is required to be less than the melting temperature of the insulating material. Specifically, the material of the first metal conductor may be a low-temperature conductive silver slurry.

In one specific embodiment of the present application, the vertical through groove structure on the surface of the magnetic core can be prepared by the first press-fitting with a corresponding mold in one-off.

In one specific embodiment of the present application, the method for soldering the pads to the first metal conductor or the second metal conductor is a commonly used soldering method in the field of inductors, and is not specifically limited herein.

To better illustrate the present application and to facilitate understanding of the technical solution of the present application, typical but non-limiting examples of the present application are as follows:

### Example 1

This example provides an inductive component with a structure shown in FIGS. 2 and 3. A preparation method for the inductive component is as follows:
magnetic powder and two windings (linear type) were subjected to a first press-fitting by compression molding (cold pressing) to obtain a magnetic core 1 and a second metal conductor; the magnetic powder was mainly composed of Fe—Si alloy;
the insulating material 2 was subjected to a second press-fitting to coat on the magnetic core 1 by hot pressing;
the insulating material 2 was subjected to mechanical drilling to obtain fourteen vertical through holes, wherein four of the vertical through holes were used for preparing a power path 4 and ten of the vertical through holes were used for preparing a signal path 5;
a first metal conductor was prepared inside the vertical through holes, which were corresponded to the power path 4 and the signal path 5, respectively; and
a pad 6 was formed on the surface of the first metal conductor and the second metal conductor, respectively, by electroplating to obtain the inductive component.

### Example 2

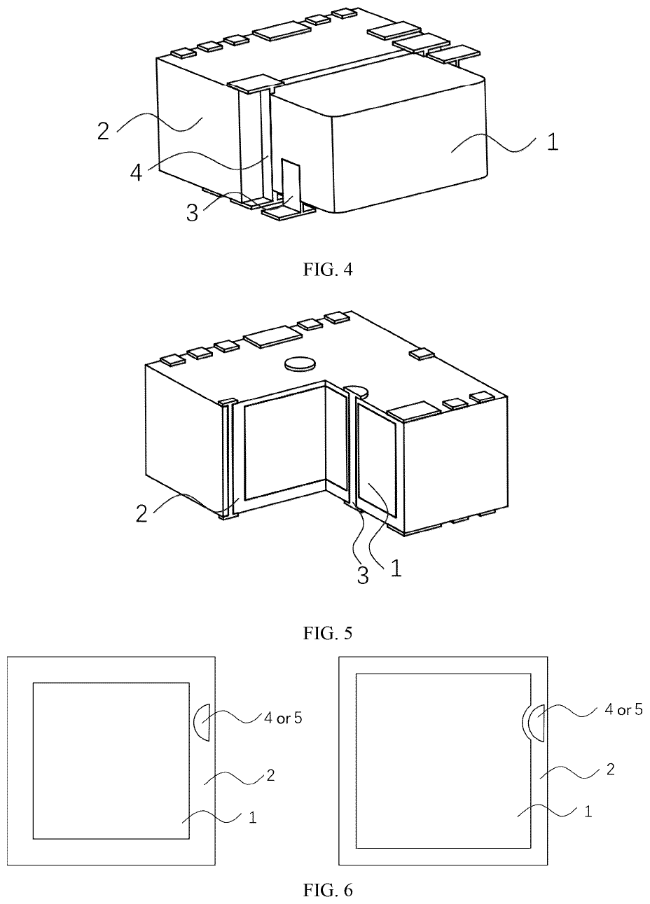

This example provides an inductive component with a structure shown in FIG. 4. A preparation method for the inductive component is as follows:
magnetic powder, two windings 3 (Z-type), and four power paths 4 were subjected to a first press-fitting by compression molding (cold pressing) to obtain a magnetic core 1 and a second metal conductor;
the insulating material 2 was subjected to a second press-fitting to coat on the magnetic core 1 by injection molding;
the insulating material 2 was drilled to obtain ten vertical through holes for preparing a signal path;
a first metal conductor was prepared inside the vertical through hole, which was corresponded to the signal path; and
a pad was formed on the surface of the first metal conductor and the second metal conductor, respectively, by electroplating to obtain the inductive component.

### Example 3

This example provides an inductive component with a structure shown in FIG. 5. A preparation method for the inductive component is as follows:
magnetic powder was subjected to a first press-fitting by compression molding (hot pressing at 150° C.) to obtain a magnetic core 1, and the magnetic core 1 was subjected to mechanical drilling to obtain through holes for preparing a winding 3;
the insulating material 2 was subjected to a second press-fitting to coat on the magnetic core 1 by hot pressing, and meanwhile the insulating material 2 was filled in the through holes;
the insulating material 2 was subjected to secondary mechanical drilling to obtain three vertical through holes for preparing a power path, eleven vertical through holes for preparing a signal path, and a vertical through hole inside the magnetic core 1 for preparing two windings 3 (linear type);
a first metal conductor was prepared inside the vertical through hole, which was corresponded to the winding 3, the power path, and the signal path; and
a pad was formed on the surface of the first metal conductor by electroplating to obtain the inductive component.

### Example 4

This example provides an inductive component. A preparation method for the inductive component is as follows:
magnetic powder and two windings were subjected to a first press-fitting by using a mold to obtain a magnetic core with fourteen vertical through grooves on the surface and a second metal conductor;
the insulating material was subjected to a second press-fitting to coat on the magnetic core by hot pressing;
according to the position of the grooves, the insulating material was drilled (wherein a hole diameter was less than the groove diameter) to obtain fourteen vertical through holes, wherein four of the vertical through holes were used for preparing a power path, and ten of the vertical through holes were used for preparing a signal path;
a first metal conductor was prepared inside the vertical through hole, which was corresponded to the power path and the signal path, respectively;
a pad was formed on the surface of the first metal conductor by electroplating to obtain the inductive component.

The preparation method for the first metal conductor inside the vertical through hole in Examples 1-4 is realized by metallization.

### Example 5

In this example, the conditions were the same as those in Example 1 except that the preparation method for the first metal conductor inside the vertical through hole was to inject the melted low-temperature conductive silver slurry into the vertical through hole, cool and cure to obtain the first metal conductor, and the size of the through hole was adjusted to facilitate casting according to the actual situation.

### Example 6

In this example, the conditions were the same as those in Example 2 except that the preparation method for the first metal conductor inside the vertical through hole was to inject the melted low-temperature conductive silver slurry into the vertical through hole, and cool and cure to obtain the first metal conductor, and the size of the through hole was adjusted to facilitate casting according to the actual situation.

### Comparative Example 1

In this comparative example, the materials of the magnetic core, windings, and pads were the same as those of Example 1, the conditions of the first press-fitting were also the same, and the difference was that the insulating resin was coated on the surface of the magnetic core by electrostatic spraying, and then the power path and signal path were connected to the component exterior by bonding. In Example 1, the footprint is reduced by 9% compared to that of Comparative Example 1.

The footprint of the inductive components prepared in Comparative Example 1 and Examples 1-4 were tested, and the results are shown in Table 1. Test method: the vernier caliper was used to test the maximum size of the inductor in the length direction and width direction, and the data were multiplied to obtain the footprint.

TABLE 1

| | Footprint (mm²) |
|---|---|
| Example 1 | 76.63 |
| Example 2 | 75.05 |
| Example 3 | 78.40 |
| Example 4 | 75.05 |
| Example 5 | 78.22 |
| Example 6 | 77.28 |
| Comparative Example 1 | 83.60 |

As can be seen from the test results in Table 1, the inductive components prepared in Examples 1-4 all have a smaller footprint. While using the preparation method in Comparative Example 1 and under the condition of the same dimensions of each component, the footprint of Comparative Example 1 is significantly larger than that of Example 1.

The applicant declares that detailed structural features in the present application are illustrated by the above examples in the present application, but the present application is not limited to the above detailed structural features, that is, the present application does not necessarily rely on the above detailed structural features to be implemented. Those skilled in the art should understand that any improvements of the present application, the equivalent substitutions of raw materials, the additions of auxiliary ingredients, and the selections of specific methods of the products in the present application shall fall within the protection scope and disclosure scope of the present application.

The above describes the preferred embodiments of the present application in detail. However, the present application is not limited to the specific details in the above embodiments, and within the scope of the technical conception of the present application, a plurality of simple variations of the technical solution of the present application may be performed, and all of these simple variations shall fall within the protection scope of the present application.

It should also be noted that each of specific technical features described in the above specific embodiments can be combined in any suitable ways without contradiction, and in order to avoid unnecessary repetition, the present application will not separately describe the various possible combinations.

In addition, any combination between the various different embodiments of the present application can also be made, and as long as they do not contradict the idea of the present application, they should likewise be regarded as the contents disclosed in the present application.

What is claimed is:

1. An inductive component, comprising:
a magnetic core;
wherein the magnetic core is externally covered with an insulating material;
the insulating material is internally arranged with a through hole; and
the through hole is internally arranged with a first metal conductor; wherein the first metal conductor comprises any one or a combination of at least two of a winding, a power path, or a signal path.

2. The inductive component according to claim 1, wherein the through hole is a vertical through hole.

3. The inductive component according to claim 1, wherein a method of arranging the first metal conductor inside the through hole is metallization or casting.

4. The inductive component according to claim 1, wherein the inductive component further comprises a second metal conductor, and the second metal conductor is arranged in contact with the magnetic core.

5. The inductive component according to claim 4, wherein the second metal conductor comprises a winding and/or a power path.

6. The inductive component according to claim 1, wherein the surface of the magnetic core is arranged with a vertical through groove structure, and the through hole is arranged in the insulating material inside the groove structure.

7. The inductive component according to claim 1, wherein the surface of the inductive component is arranged with a pad, and the pad is connected to the first metal conductor.

8. The inductive component according to claim 7, wherein the pad is independently connected to the first metal conductor and the second metal conductor, respectively.

9. A preparation method for an inductive component according to claim 1, comprising:
performing a first press-fitting to prepare a magnetic core;
performing a second press-fitting to coat the insulating material on the magnetic core;
drilling on the insulating material to obtain a through hole; and
preparing a first metal conductor inside the through hole.

10. The preparation method according to claim 9, wherein the preparation method comprises performing a first press-fitting to prepare a magnetic core and a second metal conductor.

11. The preparation method according to claim 9, wherein the preparation method comprises performing a first press-fitting to prepare a magnetic core having a vertical through groove structure.

12. The preparation method according to claim 9, wherein the preparation method further comprises soldering the pad to the first metal conductor.

13. The preparation method according to claim 12, wherein the pad is arranged on one side of the inductive component, and soldered with the first metal conductor to form a T-shape.

14. The preparation method according to claim 12, wherein the pad is arranged on both sides of the inductive component, and soldered with the first metal conductor to form an I-shape.
